(19) United States
(12) Patent Application Publication
(10) Pub. No.: US 2015/0294593 A1
(43) Pub. Date: Oct. 15, 2015

(54) Meal Planning Tool

(71) Applicants: Don Schoen, West Des Moines, IA (US); Davin Hills, West Des Moines, IA (US)

(72) Inventors: Don Schoen, West Des Moines, IA (US); Davin Hills, West Des Moines, IA (US)

(21) Appl. No.: 14/248,866

(22) Filed: Apr. 9, 2014

(51) Int. Cl. G09B 19/00

(52) U.S. Cl. CPC G09B 19/0092

(57) ABSTRACT

The invention provides a tool for communication of a meal plan devised by a health coach for an individual or group of individuals. The meal plan is designed to meet specific dietary objectives. Each meal includes food items; where possible, a list of substitute equivalent food items is available from which the individual may choose and still remain within the specific dietary objectives. The tool may include restaurant food items as well and, preferably includes means to record food consumed and means for messaging between health coach and group members.

### PRIORITY STATEMENT

This application a nonprovisional application based off provisional application no. 61/809,932, which was filed on Apr. 9, 2013 with the U.S. Patent and Trademark Office, the entire contents of which is incorporated herein.

### FIELD OF THE INVENTION

The present invention relates generally to meal planning for particular dietary objectives and, particularly, to a tool whereby a health coach can create meal plans in accordance with dietary objectives and “push” these plans to groups or individuals.

### BACKGROUND OF THE INVENTION

The relationship between health and dietary intake has never been clearer than it is today. With medical knowledge comes the awareness that a variety of health issues may be addressed, managed or even counter-acted by carefully managed nutritional intake. Further, with our ever-present focus on physical fitness which includes work-out routines, the link between nutritional intake and physical fitness activities and goals becomes clearer.

In a somewhat recent development, the personal trainer role has been augmented by the addition of a health coach. A health coach may also participate in a medical team approach to assisting someone with needs related to dietary intake for the purpose of boosting immune response, or lowering cholesterol, or managing blood pressure. Health coaches often play a role in diabetic management or management of any number of other disease states or even for pre- and post surgery diet needs. And there is certainly a place for a health coach relative to weight management.

Health coaches typically take on a role that involves physical fitness. This role may or may not include recommended activities but typically includes recommended nutritional intake relative to calories, fats, proteins, sugars, carbohydrates, even vitamins, minerals, fiber, and other components including allergens, artificial flavors and colors, etc.

Following a meal plan created by a Health Coach can be daunting. Unless tailored specifically to an individual (which would be a very expensive service indeed) such a meal plan often includes foods the individual does not like or does not like to prepare or cannot be obtained by the individual or in the current season or in the present locale. Or requires items that the user cannot readily or confidently substitute with menu items at a restaurant. These difficulties—ranging from mild annoyance to impossibilities—often result in non-compliance and failure. Where a diet is specially designed to include various nutrients or nutritional profiles, and take into account certain characteristics of the user, noncompliance can be very detrimental to the overall success and health of the person for whom the diet was designed.

Often, a person wishing to manage his diet relative to a particular goal will purchase a book or commercially available program that purports to include an effective diet. But for obvious reasons related to distribution, the book or program is geared toward the “average” person who wants to achieve that dietary goal but it may not provide an appropriate or effective meal planning tool for—or may even provide information that is detrimental to—the person who purchased the book or the program. For example, a person allergic to nuts would have to be on careful lookout for things suggested by the book or program that included nuts; and would then have to determine a substitute for all ingredients that call for nuts. But that substitution likely will not include the same level of proteins that nuts would have contributed, or includes higher sugar or calories than the required ingredient and, therefore, by making a substitution on his owner, the user has altered the balance of the intake recommended by the book or the program and does not have a ready means to avoid those consequences.

What was needed was a tool that could be used by a health coach to design a diet for a particular group of individuals or an individual. What was also needed was a tool that would allow the individuals in the dieting group to select from equivalent substitutes either of a food item or of an ingredient in a recipe. Also desirable was a tool that could recommend several different equivalent commercial brands of a food item, or provides means to substitute restaurant food items as needed. Further, for the safety of the users, a tool was needed that would include means for monitoring ingredients in the recommended foods on a particular diet relative to a user's specific needs e.g. allergens, sugars, certain food dyes, etc. Finally, a tool that will allow the health coach to communicate with the user regarding successes and failures, and to provide suggestions for success, would be advantageous.

### SUMMARY OF THE INVENTION

The present invention comprises a planning tool for the development and provision of meal plans for groups of individuals. The power and uniqueness of the tool stem from its flexibility, unique delivery method and monitoring capabilities. While the health coach can create a meal plan having specific nutritional goals for the group and deliver or make it available to each individual in the group, the tool provides an individual in the group who has certain dietary restrictions or does not like some of the food items on the meal plan, the ability to meet those goals through substitutions evaluated by the tool.

A basic workflow present in the invention is shown at FIG. 1. At its most general, the workflow begins with the creation of a meal plan by the health coach which is pushed to the individuals in a group. The individuals then use the tool to create meal plans in accordance with the health coach's plan and the individual user's preferences or health needs if any.

Many diets exist with a variety of meal plans associated with them. They differ in nutritional focus. One diet may focus on fat or calories while another may focus on carbohydrate intake, and a third may be intended to control sugar intake for a chronic condition such as diabetes.

The tool of the present invention allows all of the above-mentioned plans to be built, distributed, and monitored via a single tool.

Health Coach Tool Usage

Step 1. Coach Creates a Meal Plan

Coach gives a meal plan a name and selects an indicator regarding whether the diet repeats and, if so, on what intervals. Typically, the meal plan will be assigned to a group of clients with related nutritional needs. For example, a diabetic group.

Step 2. Coach Defines Phases by Time and Content

A number of nutritional plans are designed to cause the body to have certain biophysical or biochemical reactions. Often those diets are created to have phases that are defined by time or other characteristics. Phases of a particular diet are set up by assigning a specified number of days for each phase. For example, the first phase lasts for 6 days and a second phase lasts for 1 day.

Each phase may include daily requisite nutritional values, e.g., 1800 calories per day and restrictions, e.g., less than 3200 mg Sodium. These limitations or conditions can then be distributed throughout a day's meals by percentage or some other relative measurement in accordance with the coaches instruction and design.

Instead of, or in addition to nutrition values for a day and/or per meal, each meal can be defined using Food Tags. The use of Food Tags provides more control to the user. For example, breakfast in a particular diet may require 1 Cereal, and 1 Juice where “Cereal” is a tag and “Juice” is a tag. These tags represent a set of products, recipes and/or restaurant menu items e.g., the cereal tag contains (Cheerios and Wheaties) or some other list of cereals for this particular diet from which the user can choose. Tags may also include links to acceptable recipes for food items that meet the nutritional criteria for that meal. Finally, tags may include specific menu items at particular restaurants providing even more flexibility.

Further, the coach might provide and prescribe specific nutritional guidelines for a day, both by minimum and maximum values, and recommended division of those values through a specified number of meals and/or snacks. As an example, 1800 calories with minimum protein of 50 grams, maximum fat of 65 grams, and maximum carbohydrates of 300 grams which is distributed at 25% for breakfast, 15% morning snack, 25% for lunch, 10% for afternoon snack, 25% dinner. These values might be set according to a calculation that takes into account each user's weight, age, sex and activity level or may be determined in accordance with a set ratios of fat/protein/carbs. In any event, the diet may be set forth by specified foods, or by specified food tags between which the user may select appropriate substitutes. And the coach may set certain limitations on a per user basis, with an overall nutrition intake tailored to the group's goals and, if desired, to each individual in the group.

Step 3. Coach Pushes the Meal Plan to the User

Typically, the system communicates the diet requirements to a group of individuals or to an individual via email, web application, or mobile application or a combination of these methods.

Step 4. User May Tailor the Meal Plan

Once the diet is delivered to the user (or the user accesses the diet) the user may follow the diet either verbatim, or by selecting from the listed items that correspond with a particular tag. The user may also elect to start the diet today or a day in the future, and set a start date for a different specified meal plan in a given number of days.

Alternatively, the system may allow the user to input a particular food item and request the system to determine whether that food item may be used as a substitute for one that was recommended or specified by the coach for a particular meal. The system makes a comparison based on the underlying objectives of the plan as set by the coach, and provides an indicator of whether the desired food item is an acceptable substitute. In another embodiment, the system returns an indicator of how closely the desired substitute compares with the preselected food item, or assigns a rating to the substitute which is indicative of its coherence with the coach's objectives for the plan or for that meal.

In yet another embodiment, a user can be provided daily nutritional guidelines and the user may design his/her own meal plans by choosing food items from lists and/or databases; the system will analyze the choices and return information that tells the user which aspects of the coach's recommendations are not being met or whether the objective nutritional values are met by those choices. In yet another embodiment, the tool may then recommend specific food items that would allow the user to comply with the coach's recommendations for that diet, preferably with the minimal disruption to the meal plan constructed by the user.

Step 5. User records consumption. This can be accomplished in several ways; the most typical being a toggle between consumed and not consumed for each food item on the meal plan. In another embodiment the recordation includes a proportion of the serving that was consumed. In still another embodiment, recordation includes a measurement indicating how much of that food item was consumed. Most often the system is facilitated by electronic means that include at least one computer configured to deliver the meal plan to the user, allow the user to substitute items, and to allow the user to record food intake.

Step 6. Coach reviews user's recorded activities. In one embodiment, the coach is provided access to the information recorded by the user. The coach may elect to comment, encourage, provide suggestions, or otherwise communicate with the group or with an individual user. In an embodiment, the user and the coach may correspond privately or on a bulletin board that provides access to all users in the group. Alternatively, the group members may be assigned to each other as partners and provide to each other encouragement or suggestions in a quasi-mentoring arrangement which may be instead of or in addition to communication with the health coach.

Other Features

In some embodiments, the tool is equipped with a smart search tool which allows both coach and user to filter products, recipes and restaurant menu items by the nutritional guidelines set for a particular meal plan. For example, if the meal plan is to sodium management, the tool may be queried to provide a list of snack items containing less than a preset amount of sodium per serving. In one embodiment, the tool can return the list in order of sodium content. As another example, the search tool may be used to find a list of entrees that fit a set of criteria e.g. a past dish with less that X grams of fat or Y calories or both. In some embodiments, the tool includes suggestions for making a desired substitute more acceptable. For example, if the user wishes to substitute a salad at restaurant and its fat content is too high, the system may suggest a low fat dressing and low fat cheese as substitutes.

The tool is preferably also equipped with means for the coach (or the user) to record allergens, dislikes, or specific foods or ingredients to avoid in a profile. This feature can be extremely helpful in a variety of settings, including health coaching for older people, or for parents learning to manage a diabetic child, or any person wishing to take advantage of a meal plan having specific objectives but must avoid certain food items or ingredients that others in the group may not have to avoid. When the meal plan is pushed to a particular group, the system compares each profile of each user in the group with the meal plan and an indicator (e.g. red flag) appears next to a particular food item that contains an ingredient that this particular user has indicated in his profile to be an allergen. The user can then select another food item as a substitute in accordance with the aforementioned disclosure.

To pull the above description together into a coherent picture the following examples are provided:

### EXAMPLE 1

The coach designs a meal plan for a particular group with common dietary goals, restrictions or objectives. The restrictions and objectives are recorded with the plan and used for providing or evaluating possible substitute food items. The user receives the meal plan, for example, a meal plan named “Low Fat Diet”. The meal plan defines a breakfast of cereal and juice that lasts for 6 days. This is followed by a single day that the user can eat whatever they wish. This pattern is then repeated indefinitely. The user wants to know which cereals are acceptable and at what amounts and selects the tag “cereal”. Five cereals are returned as acceptable substitutes, but one includes a red flag because the user is allergic to strawberries and the particular cereal includes dried strawberries. The user selects one of the other four cereals, and records the amount consumed along with the volume of milk.

### EXAMPLE 2

For lunch the meal plan calls for one of several sandwiches on whole wheat bread. The user is planning to have lunch at a well-known chain restaurant and wants to know whether the club sandwich there might be substituted. The user selects the turkey and cheese sandwich from the meal planner and selects a restaurant and the club sandwich on that restaurant's menu. The tool returns a message that this sandwich includes too much fat, but suggests removing cheese from the sandwich to meet the meal plan requirements. For dinner, the meal plan suggests pasta and grilled vegetables; this item includes a red flag because the user is allergic to tomatoes. The user selects this food item and a list of substitutes that meet the objectives and restrictions of that meal plan is returned. The user selects one of these and the recipe is provided.

After each meal, or at the end of a day, the user records the food items consumed (perhaps by point and click and/or fill in the blank data entry). If he has questions, he may post them for the health coach via one of several types of messaging regimes that can be incorporated into the tool. The health coach can respond to these questions. Alternatively, the health coach may monitor the user's intake and provide comments, suggestions, or even encouragement via the associated messaging tool.

Much more complex meal plans can build around things like pre and post surgery diets. For example it might contain 30 days of specific meals leading up to the surgery and an all-liquid diet for 10 days after and then end.

FIG. 2 provides a screenshot of the health coach meal planning setup screen. The top shows the naming of a meal plan. Farther down the coach can define phases or periods and then define how long the phase/period is and what it should include for nutrition and specific meal content.

In order for the system to work as described, several databases (or a relational database) are employed. These databases include food items and every ingredient in each food item as well as specific nutritional characteristics of that item on a per serving basis along with a measurement of a serving; recipes for food items that list quantities and each ingredient, along with directions for preparation. And lists containing restaurant menu items and associated information about their nutritional values. Nutritional values of major restaurant food items are becoming more and more publicly available making the inclusion of this information more possible than ever before.

Assigning to a Group

After building a meal plan a health coach can assign it to multiple groups of consumers. For example, a health coach may be working with several different groups, one of them being a diabetic group. Another group may be of persons who have reached a weight goal and wish to maintain it. A third group may be persons managing heart disease, or high blood pressure, etc. The health coach may elect to assign “a Low Fat Diet” to the diabetic group that consists of 100 people. This is accomplished via a mechanism similar delivery of information to a group through electronic mail, or mail merge, etc. Selecting the group then pre-populates information related to meal planning for each member of that group.

Consumer Tool Usage

Meal plans assigned to consumers/patients by the Health Coach will appear in the planning portion of the consumer application. Each user has the ability to review the plan assigned to him and to start a plan and stop a started plan. He may review the details of each meal in the plan, and determine which food items he may wish to substitute, and can use the system to determine which substitutes would be acceptable within the guidelines of the plan which guidelines were set by the health coach.

In FIG. 3, a list of meal plans assigned to a specific consumer/patient is shown. From here the user can review all the meals and nutrition assigned to the user by a health coach. The user can start or stop a plan.

FIG. 4 shows what a started plan will show the user/consumer. It lists the meals they should be eating, the nutrition of those meals and in the case of breakfast the specific items they should be eating. It also shows a small tracking bar to show the user's daily progress.

The graphic at FIG. 5 shows a meal plan after the consumer/patient has filled out his plan by recording what he has consumed. It will graphically show the user items that fit the plan and items they should not be having, as well as totals for the whole day.

If used in combination with an automated shopping list tool (most preferably one that includes an inventory tool for tracking used items from a user's pantry), the meal planner can populate a shopping list with items from the meal plan, or ingredients from the recipes for items selected either by the health coach or by the user as a substitute for items recommended by the health coach.

The above description provides both a general and a more particularized description of features and functions that may be combined to create a meal planning tool of the present invention.

### BRIEF DESCRIPTION OF THE DRAWINGS:

FIG. 1 Basic work flow chart depicting the process embodied by the present inventions;

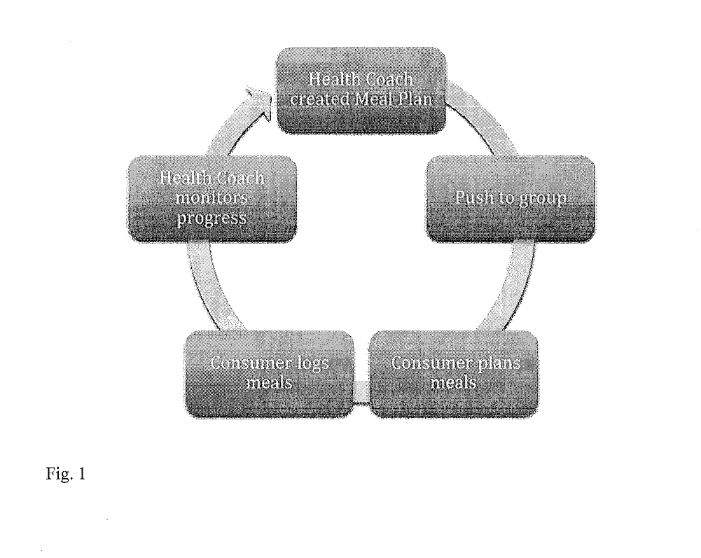

FIG. 2 Screenshot of health coach meal planning setup screen;

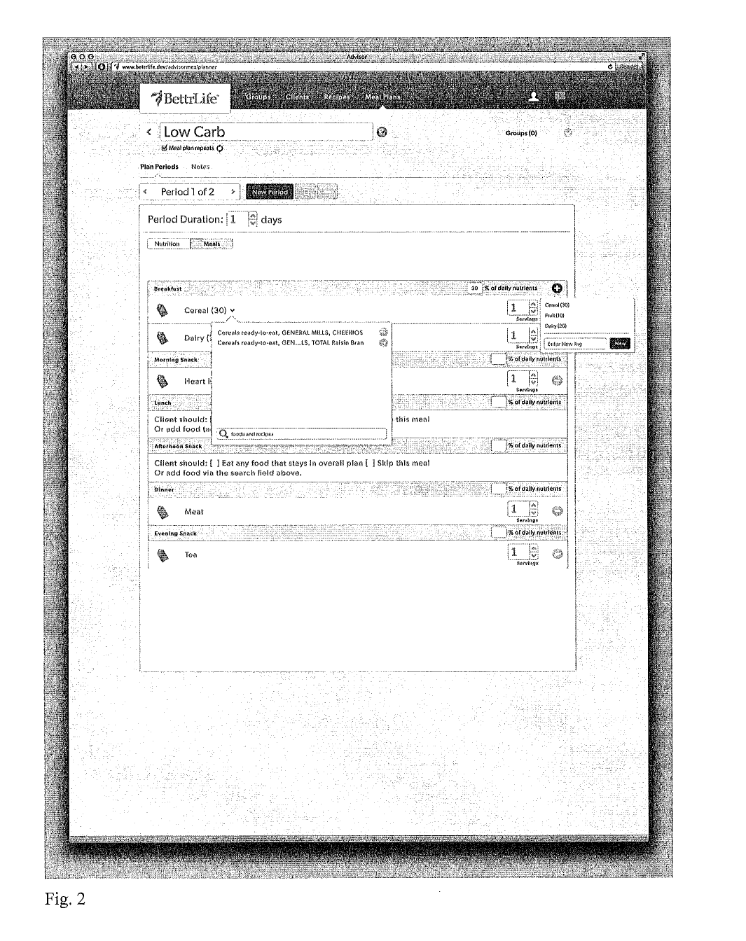

FIG. 3 Shows a list of meal plans assigned to a specific user;

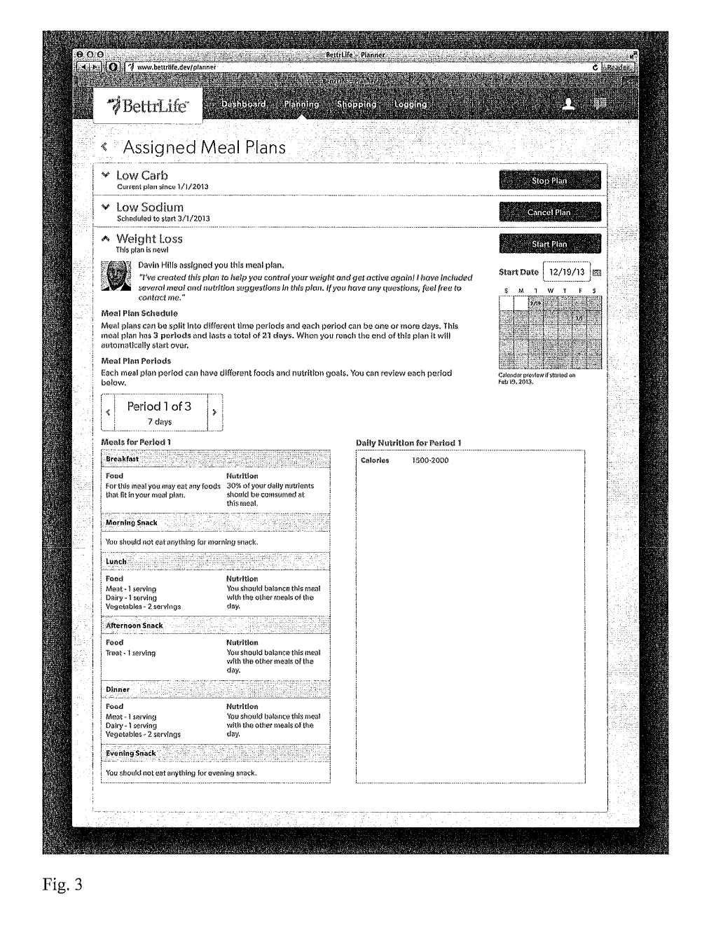

FIG. 4 Screenshot showing a dashboard that includes current meal plan, overview of this dates planned meals, search bar, and menu of functions accessible from this point;

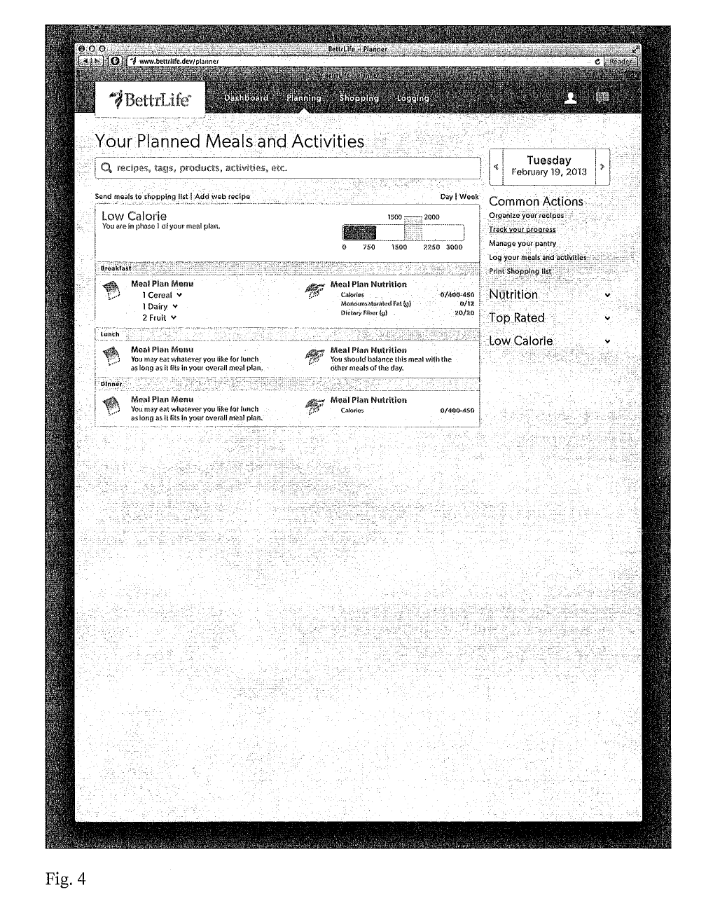

FIG. 5 Shows the dashboard of FIG. 4, with the breakfast expanded to show items and values recorded by user.

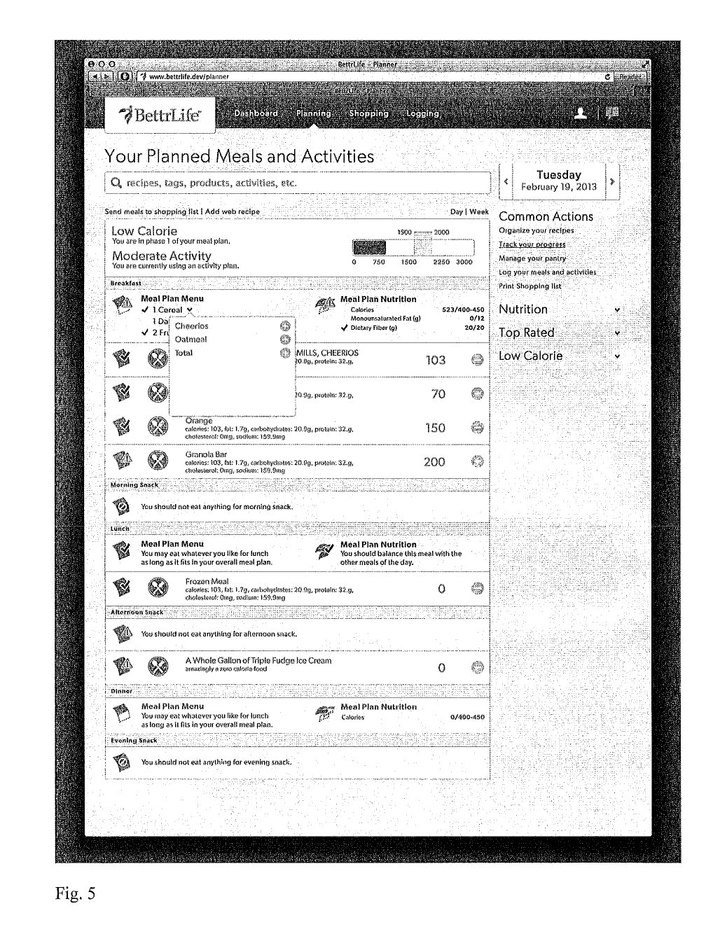

What we claim is:

1. A meal planning tool comprising one or more computers configured to facilitate creation of a meal plan by a health coach, said meal plan tailored to meet specific dietary objectives, wherein said tool allows the meal plan to be communicated via electronic means to at least one individual.

2. The meal planning tool of claim 1 wherein said meal plan includes at least one food item, at least one of said food items identified by a tag.

3. The meal planning tool of claim 2, said tag further associated with a at least one other food item, said at least one other item interchangeable within the tailored meal plan.

4. The meal planning tool of claim 3 wherein said at least one individual may substitute said at least one food item in said meal plan by selecting from the interchangeable group of food items.

5. The meal planning tool of claim 1 further comprising means to record food items consumed.

6. The meal planning tool of claim 5 further comprising a messaging tool for use by at least one of the individual and the health coach.

7. A meal planning tool comprising a web-enabled program and comprising an application for a hand-held device, said web-enabled program comprising means to store a meal plan tailored to meet specific dietary objectives and deliver said plan to at least one individual through said application.

8. The meal planning tool of claim 7 said meal plan comprising a plurality of food items each identified by a tag.

9. The meal planning tool of claim 8, at least one of said tags associated with a list of interchangeable food items meeting said specific dietary objectives from which said at least one individual may select.

10. The meal planning tool of claim 7, said meal plan devised by a health coach. 11. The meal planning tool of claim 9 further comprising means for said at least one individual to record food items consumed 12. The meal planning tool of claim 11 further comprising means for said health coach to review said record of food items consumed by said individual.

13. The meal planning tool of claim 12 further comprising a messaging tool.

14. The meal planning tool of claim 13 said messaging tool including means for said health coach to communicate with said at least one individual.
